(19) United States
(12) Patent Application Publication
(10) Pub. No.: US 2010/0175046 A1
(43) Pub. Date: Jul. 8, 2010

(54) METHOD AND DATA PROCESSING SYSTEM FOR COMPUTER-ASSISTED PERFORMANCE ANALYSIS OF A DATA PROCESSING SYSTEM

(76) Inventors: Moritz Hammer, Munchen (DE); Florian Mangold, Munchen (DE)

Correspondence Address: HARNESS, DICKEY & PIERCE, P.L.C., P.O.BOX 8910, RESTON, VA, 20195, US

(21) Appl. No.: 12/450,876

(22) PCT Filed: Apr. 9, 2008
(86) PCT No.: PCT/EP2008/054288

§ 371 Date: Feb. 12, 2010

(30) Foreign Application Priority Data
Apr. 18, 2007 (DE) 10 2007 018 300.5

(51) Int. Cl. G06F 9/44

(52) U.S. Cl. 717/110; 717/131

(57) ABSTRACT

A method is disclosed for the computer-assisted performance analysis of a data processing system, wherein a program code with a plurality of code parts is running. During the execution of at least one embodiment of the method, one or more parts of the code parts are at least varied once while using a functionality creating a variance in regard to at least one criterion to be evaluated. The data processing system is executed with the varied code part and parts multiple times. A variance of the at least one criterion to be evaluated of the varied code part or parts, or of all code parts of the program code is determined. Finally, a covariance resulting from the variance is subjected to a multivariant analysis.

### PRIORITY STATEMENT

This application is the national phase under 35 U.S.C. §371 of PCT International Application No. PCT/EP2008/054288 which has an International filing date of Apr. 9, 2008, which designated the United States of America, and which claims priority on German patent application number DE 10 2007 018 300.5 filed Apr. 18, 2007, the entire contents of each of which are hereby incorporated herein by reference.

### FIELD

At least one embodiment of the invention generally relates to a method for the computer-assisted performance analysis of a data processing system, wherein program code with a plurality of code parts is running. At least one embodiment of the invention further generally relates to a data processing system with an execution environment in which the program code with the plurality of code parts is running. At least one embodiment of the invention further generally relates to a computer program product.

### BACKGROUND

A data processing system, in which a program code with a plurality of code parts is running, comprises a multiplicity of hardware and software components. Code parts comprise for example methods, procedures, functions, objects, etc. In a complex data processing system it is nearly impossible to determine the impact of individual well-defined code parts in the overall system on performance or resource consumption. In the case of resource consumption, for example, the memory space used by a code part, and its runtime, are of significance. While it is possible to determine the time and/or memory consumption of individual code parts (code fragments) by way of a measurement, the measurement data obtained is frequently difficult to analyze as an enormous number of variables are measured. The measurement data therefore often offers no pointer as to which of the individual components of the data processing system work together or belong together. In particular, it is not possible to obtain information about how the individual code parts work together. It is not possible, in particular, to obtain information about which method/which object/which procedure/or modules in general/etc. is/are dependent on which method/which object/which procedure/or modules in general/etc. Likewise, it is not possible to obtain information about how methods/objects/procedures/etc. impact on variations of other methods/objects/procedures.

During the development of the program code for running on the data processing system, it is not possible for the software developer to assess how the individual code parts within the program code and the overall system are behaving. In particular, it is possible only with difficulty to identify those code parts and hardware components which have an impairing effect on performance in the data processing system.

Up to the present time, analysis of runtime characteristics like performance and resource consumption has been carried out using profilers and static code analysis. In the case of profilers, an analysis is generally carried out by means of a call tree or by means of a call graph (in a multi-threading system). However, only reciprocal calls of the respective code parts can be detected in this way. Call trees give only a limited indication of the characteristics of a data processing system. For example, no decrease in performance by a locked object which is in shared use and is an integral component of a code part can be detected by a call tree. Profilers supply precise measurements of code parts. With some profilers it is possible to measure code variations directly in the program code and/or the data processing system. A disadvantage of profilers is that these are not capable of identifying shared factors of the data processing system.

Static code analysis allows predictions to be made about the behavior of a known data processing system. Multi-threading systems, however, elude any purposeful analysis owing to their complexity and chaotic behavior. One problem with static code analysis is that precise knowledge of the data processing system is required in order to be able to carry out a performance analysis.

### SUMMARY

At least one embodiment of the present invention is directed to a method for the computer-assisted performance analysis of a data processing system which allows statements to be made as to which code parts of a program code which is running on the data processing system work together, so as to be able to identify performance-impairing components of the data processing system.

At least one embodiment of the invention is directed to a data processing system which allows a computer-assisted performance analysis of a data processing system.

These objects are achieved by the features of the independent claims. Advantageous embodiments are described in the dependent claims.

In the method according to at least one embodiment of the invention for the computer-assisted performance analysis of a data processing system, in which a program code with a plurality of code parts is running, one or more of the code parts are varied at least once using a functionality generating a variance with regard to at least one criterion to be examined. The data processing system is executed multiple times with the varied code part or parts. A variance of the at least one criterion to be examined of the varied code part or parts, or of all code parts of the code program, is determined. Finally, a covariance resulting from the variance is subjected to a multivariant analysis.

A covariance is understood to be a measure of the correlation of two variables, in the present case of the criteria to be examined. It is not absolutely necessary here for the two variables to be different.

The principle underlying at least one embodiment of the invention is to modify an unknown program code (also called a software system) in a defined manner. The modification is carried out in one or more of the code parts of the program code in accordance with one or more criteria to be evaluated. The program code is then executed with the variation made, all components (hardware and/or software components) of the data processing system which are relevant to performance being measured. Compared with an unmodified program code, a variance of the at least one criterion to be evaluated is produced. The same code part or parts can be varied multiple times with a different value. During execution of the data processing system with the varied code part or parts, the variance of the one criterion to be evaluated of the varied code part or code parts, or of all code parts of the program code, is in turn determined. Thus, for each code part an adequate variation for statistical evidence can be carried out, the at least one criterion to be evaluated being measured in each case. The measured data is finally subjected to a multivariant analysis. In this way, the data obtained can be reduced in size, individual criteria having architectonic congruences.

At least one embodiment of the invention enables the identification of shared factors of the data processing system. The shared factors represent architectonic congruences.

The factors are numerical values which have been formed by a factor analysis. The factor analysis is used to detect structures (exploratively), and reveals architectonic congruences of modules (objects, methods, etc.) with regard to a cause of resource consumption (including performance impairment). Architectonic congruences mean that all the modules in a factor are highly similar to one another in terms of resource consumption, as a result possibly of jointly implemented functionality.

The program code is thus accessible to purposeful analysis, as intrinsic characteristics can be displayed in a simplified manner.

The functionality generating the variance can be formed e.g. by a modification of the code and evaluated by way of mathematical, in particular statistical, methods.

Multivariant analysis is a method known from statistics which, based on natural variances in samples, etc. implements a size reduction. Within the scope of at least one embodiment of the invention, however, it is not a natural variance of the behavior of the program code that is utilized, rather the variance is generated by a variation of resource-consuming code parts. Multivariant analysis is thus actively used as a structure-detecting method. The process is active because the variances are generated intentionally.

The code parts may respectively comprise one or more of the following components: methods, procedures, functions, objects. The at least one criterion to be examined may comprise the following criteria: the runtime of the varied code part or parts or of all code parts; the resource consumption (e.g. the memory consumption) of the varied code part or parts, or of all code parts, of the program code.

The analysis can be carried out in an all the more targeted manner if the one or more code parts are repeatedly subjected to a different variation in each case. In this way, in particular, the accuracy of the variance of the at least one criterion to be examined of the varied code part or parts, or of all code parts, of the program can be improved. A further embodiment, according to which different code parts are selected which are varied using the functionality generating the variance with regard to the at least one criterion to be evaluated, also contributes to this. It can also be provided that all code parts of the program code be varied multiple times.

A factor analysis or a principal component analysis is preferably used as the method of multivariant analysis, both methods being known from the field of statistics. Multidimensional scaling, cluster analysis or neuronal networks can also be used. The multivariant analysis is usefully carried out using a statistical program running in a computer-assisted manner. Multivariant analysis or multivariant data analysis is the term used to designate a collection of methods which examine multidimensionally distributed variables.

Factor analysis is used for revealing inherent structures of a set of generally dependent features. Within the scope of at least one embodiment of the invention, the criteria to be examined function as features. Within the scope of factor analysis, many features are reduced to fewer factors. Factor analysis allows simple analysis of measured data. In contrast to this, when a call tree is examined, only conditional conclusions can be reached as to a system's dependencies or performance characteristics. The same is true of static code analysis. In particular, not all dependencies are identified.

Factor analysis proceeds on the assumption that every observed value of a variable or of a standardized variable can be described as a linear combination of multiple (hypothetical) factors. In factor analysis a compression of information is thus effected.

The functionality generating the variance may, according to one embodiment of the method, consist in instrumentation of the code of the code parts, e.g. through aspect-oriented programming. The functionality generating the variance may also consist in modification of the code of the code parts themselves.

At least one embodiment of the invention further comprises a computer program product which can be loaded directly into the internal memory of a digital computer and comprises software code sections with which the steps of the method described above can be executed when the product is running on a computer.

At least one embodiment of the invention further comprises a data processing system, with an execution environment in which a program code with a plurality of code parts is running, which comprises means for executing the method described above.

### BRIEF DESCRIPTION OF THE DRAWINGS

Embodiments of the invention will be explained in detail below with reference to the drawings, in which:

FIGS. 1 and 2 show respectively a diagram in which two factors are plotted against one another which are obtained as a result of a dynamic congruence analysis of the runtime characteristics of an explicit model checker,

FIGS. 3 and 4 show respectively a diagram in which two factors are plotted against one another which are obtained as a result of a dynamic congruence analysis of the runtime characteristics of a further data processing system,

FIGS. 5 to 9 show respectively code parts of a program code with which the dynamic congruence analysis of runtime characteristics is explained, and

FIG. 10 shows a diagram in which two factors are displayed against one another which are the result of multivariant analysis of the program code from FIGS. 5 to 9.

### DETAILED DESCRIPTION OF THE EXAMPLE EMBODIMENTS

Within the scope of the present invention, embodiments of the computer-assisted performance analysis of a data processing system is described in which a program code with a plurality of code parts is running.

The problem with the performance analysis of large modern data processing systems is that it is less and less comprehendible where performance problems originate. Individual code parts can to a certain extent be optimized without difficulty. However, it is not clear in what manner the code parts work together. Furthermore, performance problems arise through the interaction of code parts with one another. For example, one code part locks a resource, e.g. a memory, as a result of which other code parts have to wait before accessing the memory. Using factor analysis, it can be understood which code parts in the data processing system are specifically working together.

The underlying idea here is to analyze correlations. In a program code which is executed once, no correlations in the runtimes can be observed. Even if a program code is executed very frequently, correlations in runtime measurements will not necessarily be discernible. This stems from the fact that code parts of the data processing system can behave in a very deterministic manner, yet be highly correlated. Correlation is defined as a standardized measure of the linear relationship between two variables. Covariance is therefore critical to correlation. Covariance is a measure of the relationship between two variables. It is positive if the variables have a positive relationship in the same direction. If the value of one variable increases, then the value of the other variable also increases. Covariance is negative in cases where there is a reciprocal relationship. In concrete terms, this means: where covariance is zero, the variables have no relationship or a non-linear relationship. In performance analysis, non-linear relationships do not have to be considered.

For the performance analysis according to at least one embodiment of the invention, variance in the data processing system therefore has to be generated in order that the covariance can be measured and determined. Variance can be generated in diverse ways and then measured in the data processing system. Within the scope of the example embodiments described hereinbelow, the program code has been instrumented using AspectJ. The functionality generating variance could, however, also be implemented directly in the program code. Instrumenting presents the most practicable solution as the system to be examined can be looked at as a black box, with no direct intervention in the program code needing to be made. The instrumented program code is now executed multiple times. As a result, the instrumented program code now has variance in its runtime. The runtimes of all the code parts to be observed are measured as the program code is running.

As a result of multiple execution of the program code with differing variation, measurements exist of the data processing system with variations in its runtime. Through the variance of individual code parts, the resulting covariance is analyzed using a statistical program with the aid of factor analysis. Factor analysis is used in order to reduced in size multidimensionally distributed criteria. Factor analysis is commonly used as a mathematical tool in statistics, as many variables between which a relationship is produced are frequently recorded in that field.

To this end, the measured data is read into the statistical program and a factor analysis carried out. Factors are output by the program in a multidimensionally scaled manner. Multidimensionally in this context means that each of the (hypothetical) factors found represents a dimension and the measured modules are shown scaled in relation to their factors. If, for example, the runtime of a “main method” is dependent on two factors, it is represented proportionately through vector addition to these factors in a diagram.

Multidimensional scaling often makes analysis of the hypothetical factors found easier. Performance-engineering dependencies which previously may possibly not have been known can now be visualized or determined in a computer-assisted manner. If, for example, two modules block one another through a resource whose use they share, then these exhibit the same covariance and are thus recognizable in a diagram as being correlated. These two code parts can now undergo revision, the code part of the modules being modified if there is potential for optimization, which leads/may lead to a better runtime.

If a code part has been modified and the impact of the modifications are to be visualized or if the data processing system is still not behaving sufficiently well in terms of its performance, then a new database with the new, varied data processing system has to be created. The data processing system which has been varied in its runtime by the modification of the code part has to be executed afresh. In the process, the runtimes of the individual code parts are re-measured.

The inventive performance analysis procedure using factor analysis extends existing profiling methods, it making no difference whether the data processing system to be analyzed is asynchronous or synchronous. Conventional analysis methods indicate code parts which exhibit a poor or excessively poor performance. With the aid of the artificial variance which is analyzed by way of factor analysis, underlying “causes” or factors become clear. For example, it is possible with this method to detect performance problems which arise due to the shared use of resources.

The procedure in practice is as follows: an unknown software system is interwoven with aspect-oriented code which varies individual well-defined code fragments (code parts) in its runtime. The software system is executed with this variation and the runtime of the modules of interest is measured and stored. After this, the same module is varied again with a different time interval or a different module is varied in its runtime. The system is executed afresh and the runtimes of the modules are measured and stored. Each module of interest is prolonged with a predetermined number of different additional intervals. The measured data yields a matrix or a table. The matrix is now processed further with a statistical program. As a result of the prolongation of individual modules, other modules which are dependent on these modules have to wait longer. The variance in the runtime which is caused by the waiting can thus be explained by another part of the variance (the prolongation).

To this end, factor analysis or a principal components analysis is applied to the dataset in the statistical program. The aim here is to find hypothetical factors which describe the correlation of the runtime measurements. Factor analysis is thus used as a set of structure-detecting analytical instruments. In this context, it is also referred to as exploratory factor analysis.

In the following example embodiments, correlation matrices formed in the course of the analysis are represented graphically in a vector diagram. Linearly independent data is represented by orthogonal vectors. In general, the angle between the vectors corresponds to the cosine of the correlation coefficient.

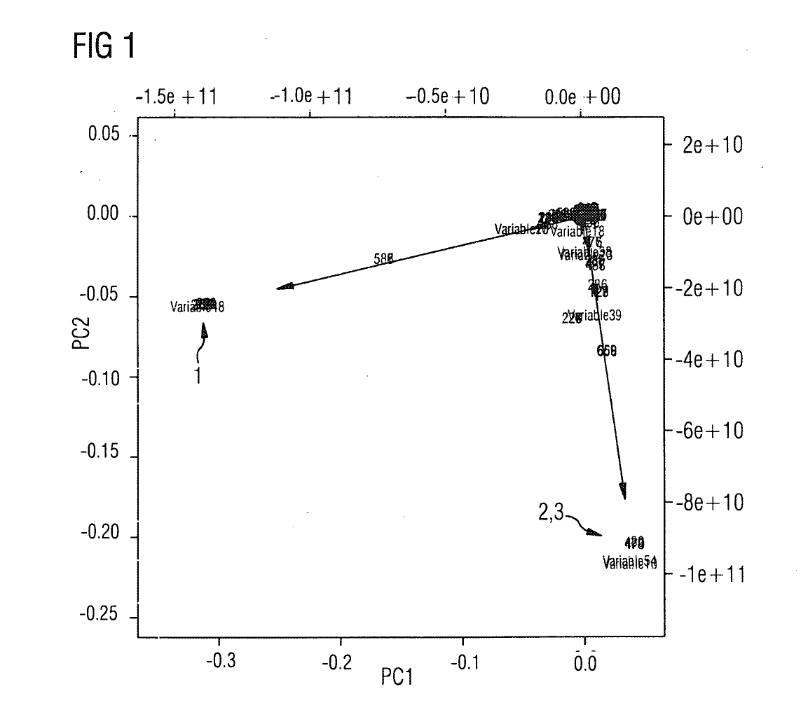

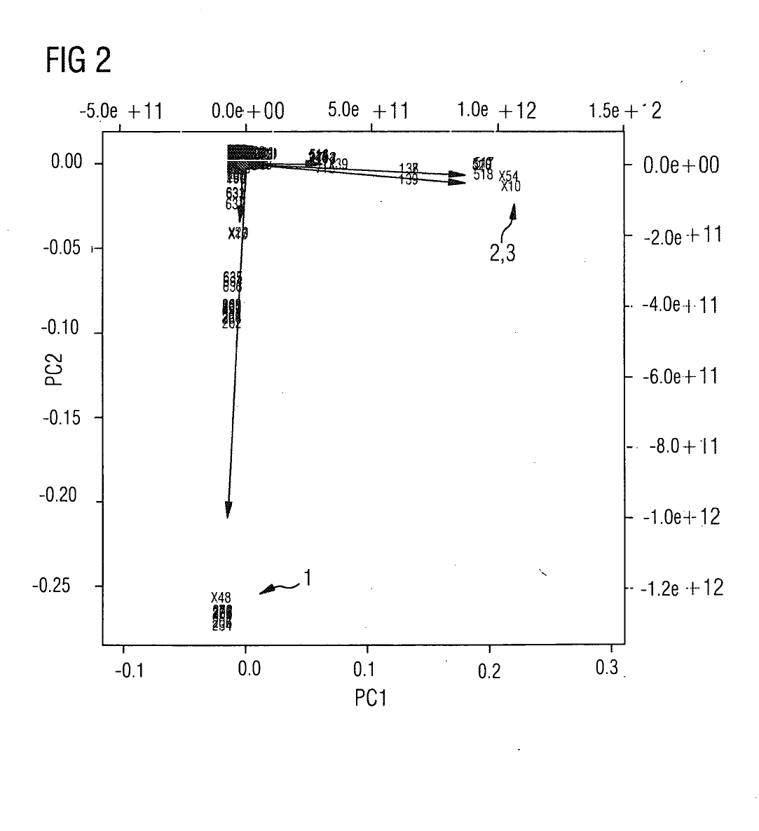

FIGS. 1 and 2 demonstrate the application of factor analysis on an explicit model checker. Such a program performs the search in graphs, some of which are large, representing the transition system of a compactly modeled program. Here, an “on-the-fly approach” is followed: instead of constructing the graph fully and subsequently searching, construction and search are combined. Accordingly, two separate tasks are solved: for a given state, successor states have to be worked out, and the search algorithm has to be applied to these successor states. As the search algorithm has to avoid revisiting states that have already been searched, a hash table is used in order to store states that have already been visited. It is known from experience that the bulk of the search algorithm's time is used in computing the hash codes for the states.

FIG. 1 shows factors PC1 and PC2 of the explicit model checker which are plotted against one another in a vector diagram. FIG. 1 comprises the view of the runtime when the model checker is running. The two factors—computation of successor states (variable 48, reference character 1) and lookups in the hash table (variable 54 and variable 10, reference characters 2 and 3, where variable 10 stands for the computation of the hash code) are indicated in the Figure by vectors, using which total time consumption can be illustrated. Variables 10, 48 and 54 correspond to the measurement of the runtime of a corresponding code part. This makes it clear that the runtimes of variable 48 are independent of variables 54 and 10 and vice versa. This means that optimization of the subsequent computation has no influence on the runtime requirements of the hash table. The independence of the two times from one another is evident from the orthogonal position of the vectors for variable 48 and for variable 54 and variable 10 relative to one another.

FIG. 2 shows the view of a modified model checker. In this variant, only some of the states already visited in the hash table are located in the memory. In order to give sufficient recognition to the frequently immense storage requirements, parts of the states are transferred to the hard disk. In the small examples that are used, the runtime needed for this is inconsequential. However, since the hash function is used again when the externally transferred states are input, the dependency between hash function and hash table lookup changes. Optimization of the hash function would then still have a large influence on the hash table component, as well as influencing other code parts. The diagram is rotated relative to FIG. 1. What is important here is merely that suddenly, in the modified model checker the vectors for variables 10 and 54 (reference characters 2, 3), no longer lie on top of one another, but form a small angle. The runtimes of modules X54 and X10 are no longer dependent to the same extent as in FIG. 1 (through use of the hard disk).

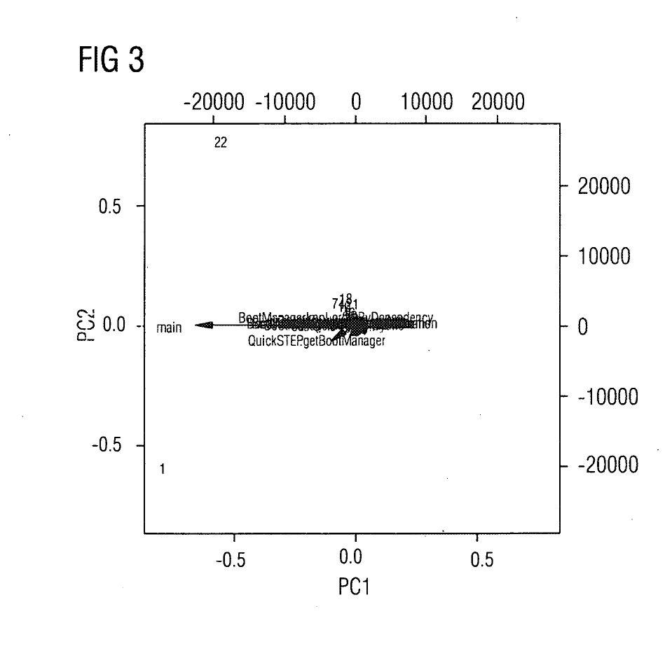

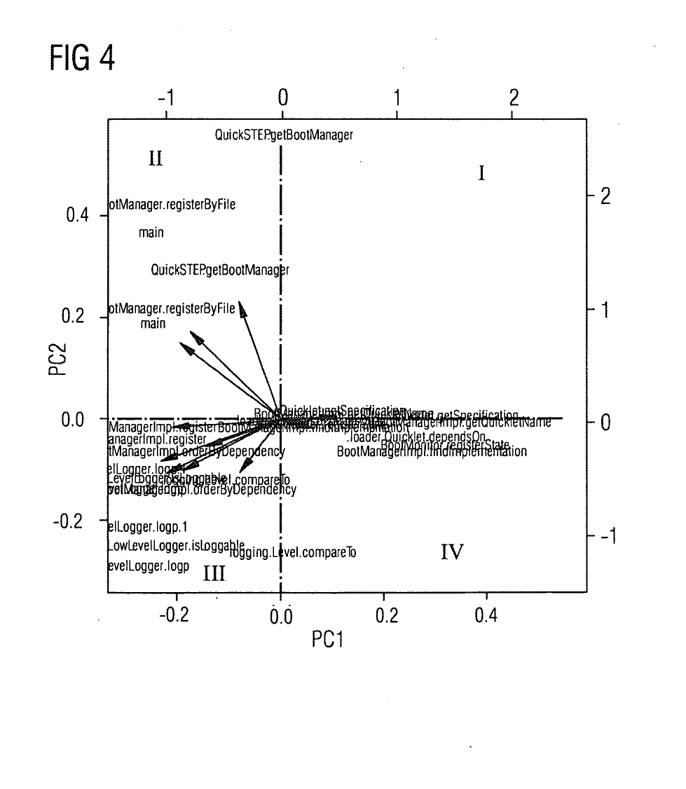

FIGS. 3 and 4 demonstrate the application of a dynamic congruence analysis of a program code which has performance problems. In this case, measurements were carried out with profilers, but due to the high level of complexity of the program code no conclusion could be drawn about how individual code parts in the system interact. For example, it is known by measurement that the method “LowLevelLogger.logp” has a major influence on the runtime of the system. However, no indication is obtained as to which code parts have to be optimized in order to obtain an improved performance of the overall system. In order to make such a statement, a high degree of knowledge about the system is required.

FIG. 3 shows in a vector diagram factors PC1 and PC2 of the overall system. Here a congruence analysis of the overall data processing system has been carried out with all JAR files of the program code. The high number of code parts in the data processing system means, however, that it is not possible to obtain a clear overview of relationships. It can, however, be seen that the vector of the method “QuickStep.getBootManager” is almost at a right angle to the vector of the “main” method. From this, it can be seen that this method is worth further investigation. This is hard to see in FIG. 3 since the arrow for the getBootManager method is very small. FIG. 4, however, is a more refined image in which the method can be more readily discerned, the latter being represented in a mirror-inverted manner here.

FIG. 4 shows a multiplicity of factors of the overall data processing system which are scaled and filtered. The factors are plotted in a vector diagram as principal components PC1 and PC2. The factors represented in FIG. 4 correspond to individual code parts. Vectors which lie in the third quadrant III can be combined to form a common factor. This factor represents a logging mechanism which occupies a large part of the runtime and is not significant with regard to the functionality of the data processing system. The vectors lying in the second quadrant II which have positive values for the principal component PC2 and negative values for the principal component PC1 influence the runtime of the data processing system by slowing the latter down.

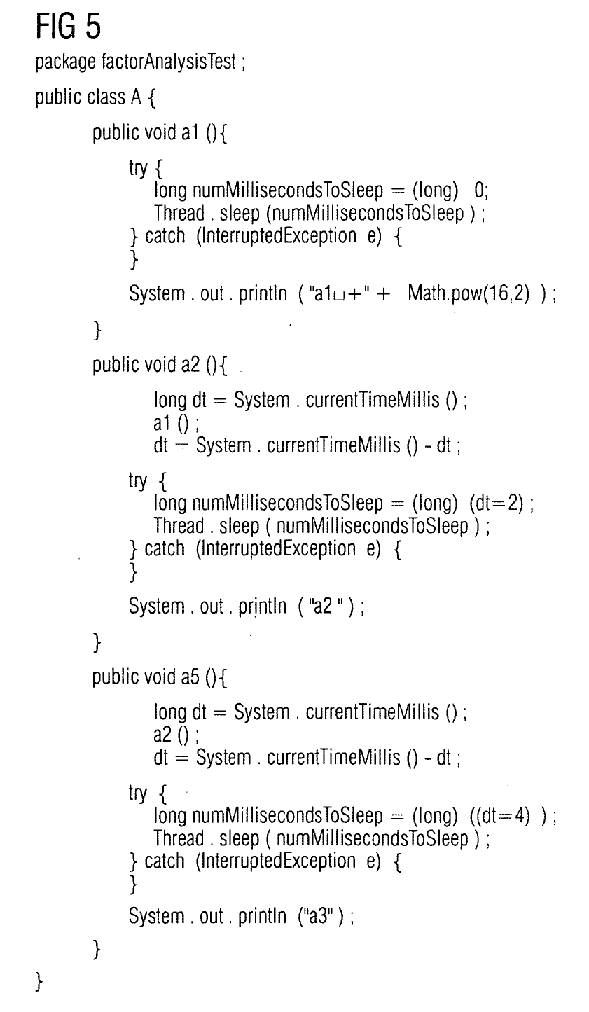

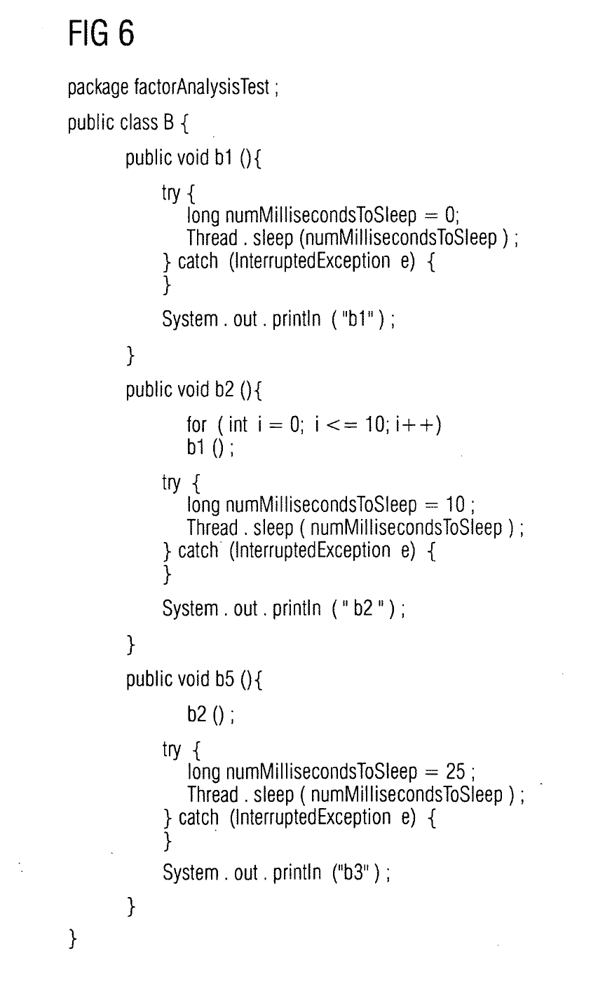

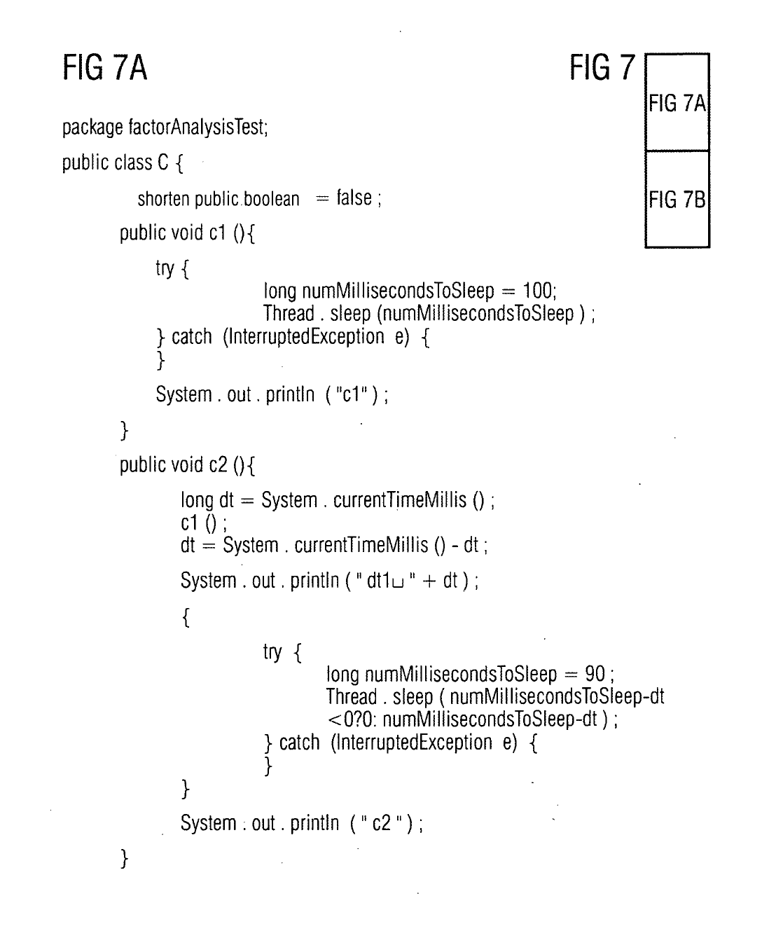

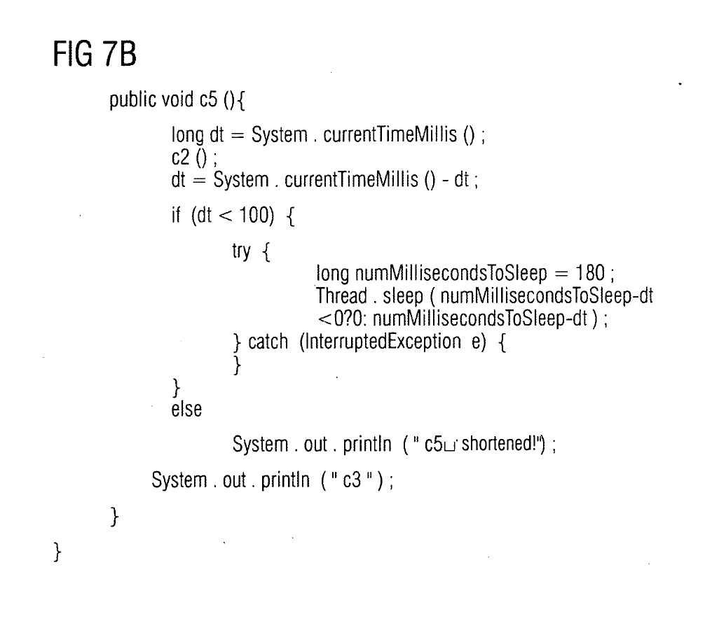

Dynamic congruence analysis of runtime characteristics is demonstrated hereinbelow with the aid of the listings from FIGS. 5 to 9, in which an example of program code to be analyzed is shown. The package “VectorAnalysisTest” contains three classes A, B and C which in turn each contain three methods. These methods call one another reciprocally. Thus, for example, method a2 calls method a1, while method a5 calls only method a2. The methods of class A correlate in a positive linear manner. This means that method a2 needs twice as long as method a1 and method a3 needs four times as long as method a2. The methods of class C interact negatively. If method c1 needs too long, then the runtimes of the other methods are shortened. The methods of class B have a constant runtime. Method b2 calls method b1 in a loop ten times.

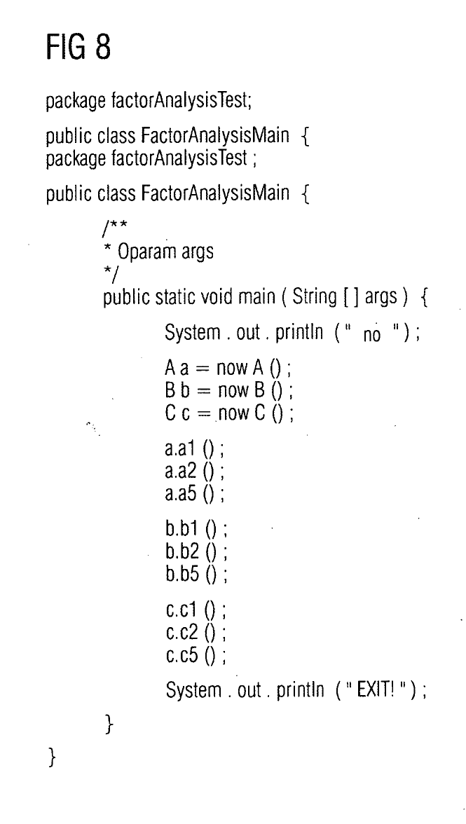

The method “main” generates the three objects a, b and c. The objects a, b and c then execute methods to be observed (FIG. 8).

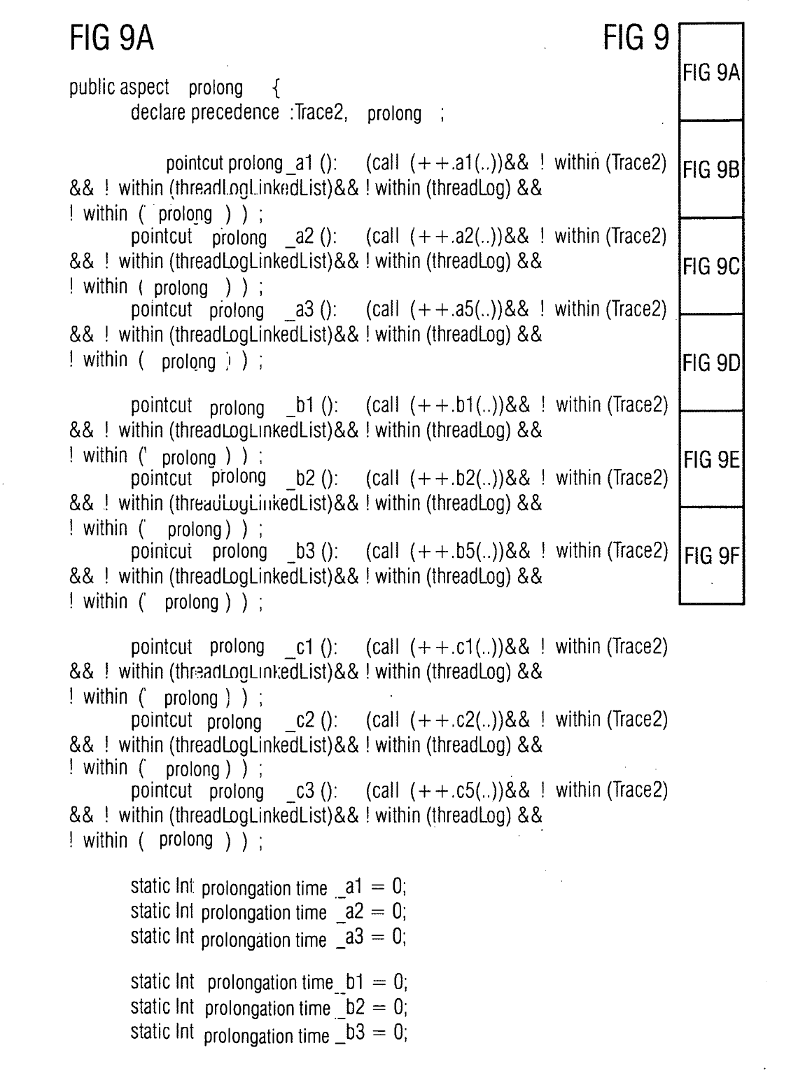

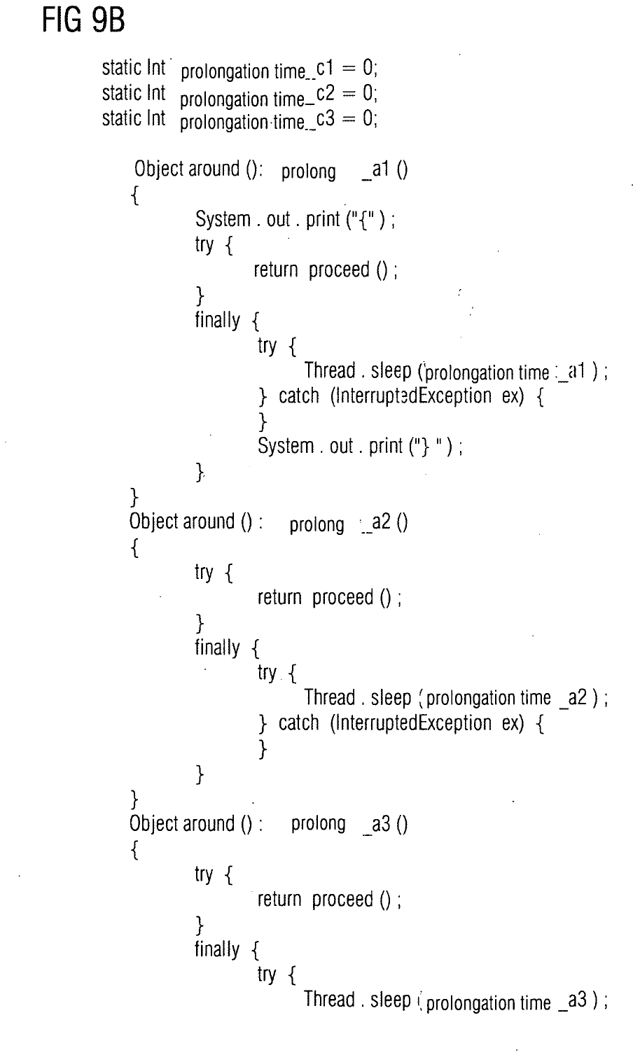

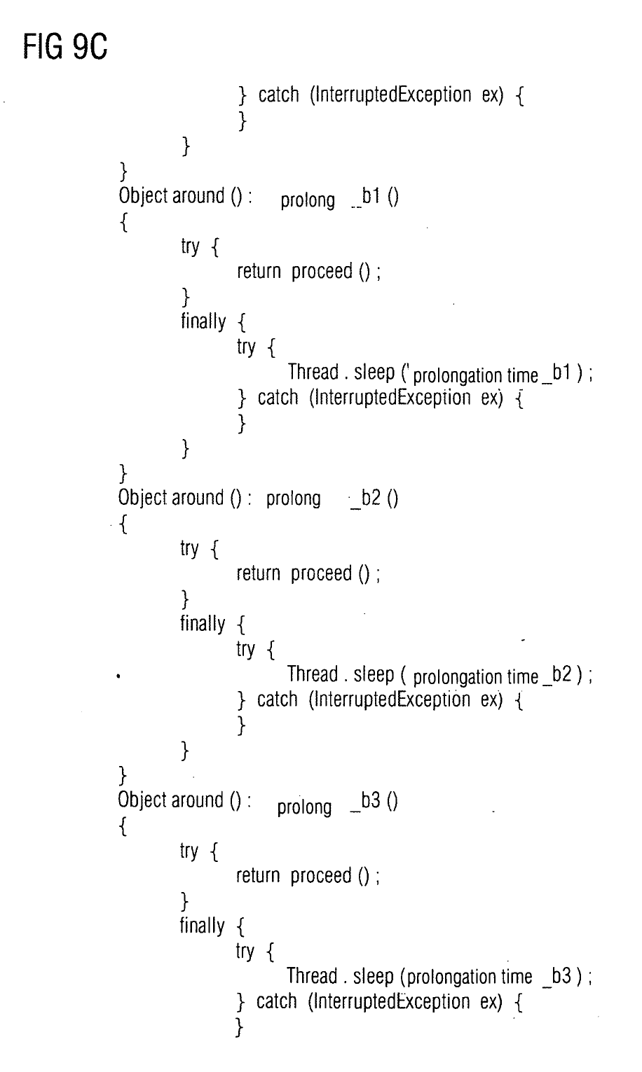

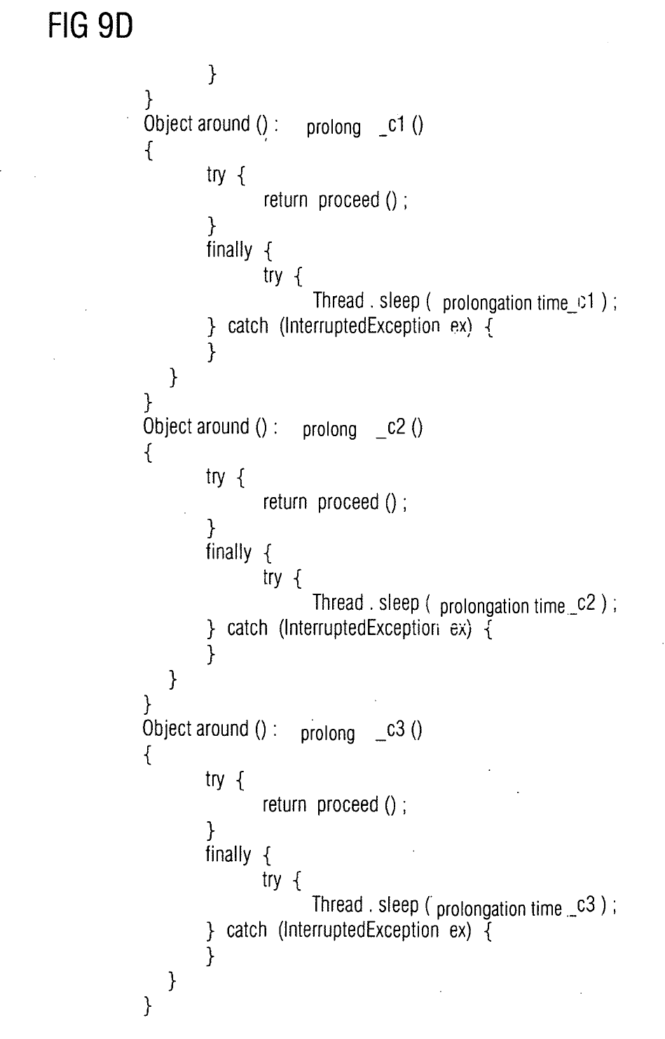

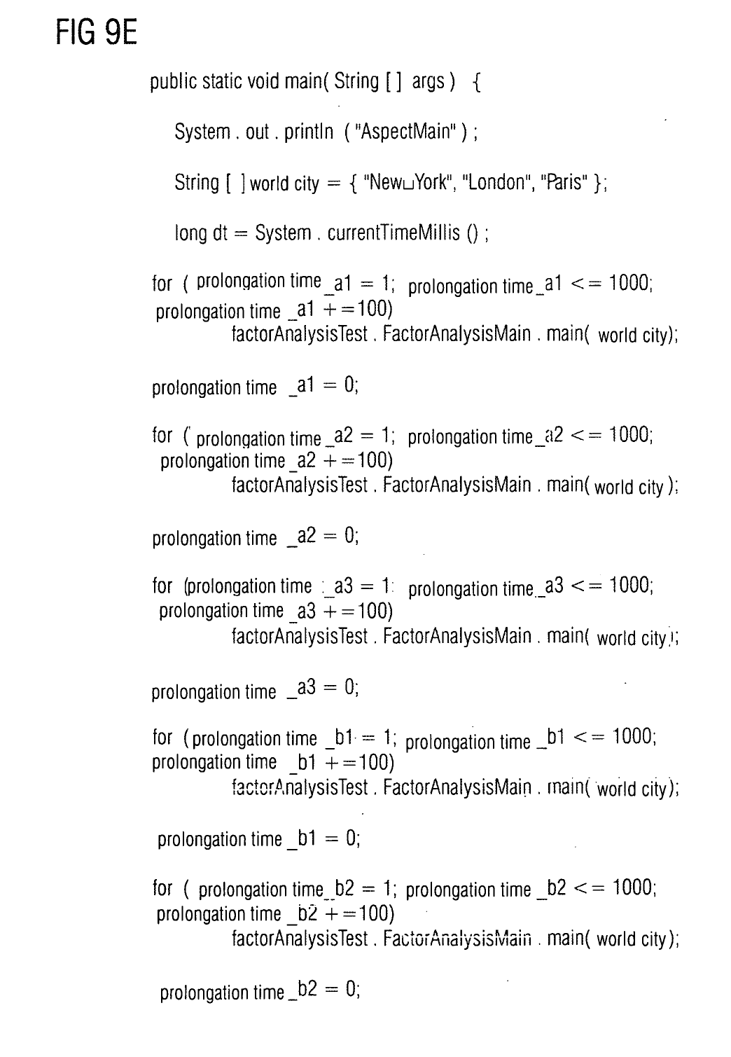

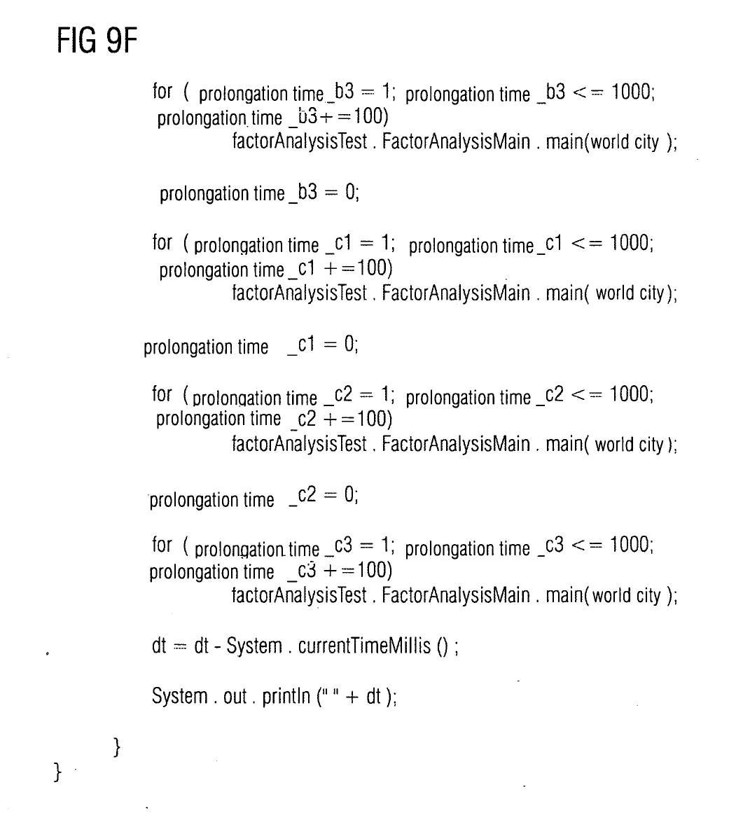

The aspect “Prolong” manages the task of varying methods (cf. FIG. 9). Each method, beginning with 1, is prolonged in steps of 100 up to 1,000 ms.

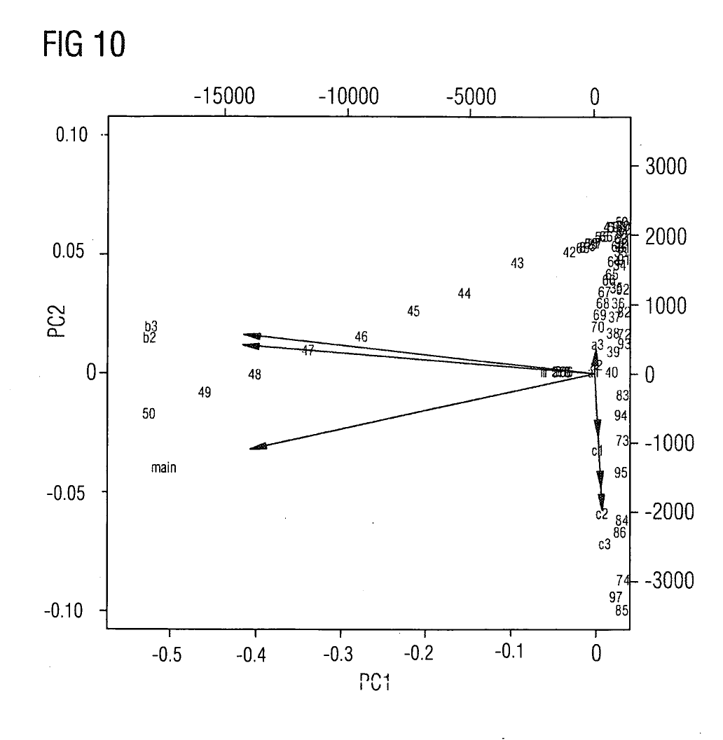

The “main” method of the aspect was executed, all runtimes being measured with the Trace2 aspect (not listed). The data can now be further processed in a statistical program. R, S-Plus or SPSS, for example, can be used as statistical programs. In this specific case, a principal component analysis, which constitutes a type of factor analysis, was carried out in R. The results are shown by FIG. 10. The individual factors of the testing program can readily be seen. The methods of the individual classes can be grouped together to form one factor. The optimizations in one class do not impact upon another class. As a result, an overview of the system can be provided, without having to carry out an examination of the individual code steps.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for the computer-assisted performance analysis of a data processing system, on which program code with a plurality of code parts is adapted to be run, the method comprising:
varying one or more of the plurality of code parts at least once using a functionality generating a variance with regard to at least one criterion to be examined;
executing the data processing system with the varied one or more of the plurality of code parts multiple times;
determining a variance of the at least one criterion to be examined of the varied one or more of the plurality of code parts, or of all code parts of the program code; and
subjecting a covariance, resulting from the determined variance, to a multivariant analysis.

2. The method as claimed in claim 1, wherein the plurality of code parts respectively comprise one or more of the following components: methods, procedures, functions, objects, modules.

3. The method as claimed in claim 1, wherein the at least one criterion to be examined comprises at least one of the following criteria:
the runtime of the varied one or more of the plurality of code parts, or of all code parts;
the resource consumption of the varied one or more of the plurality of code parts, or of all code parts.

4. The method as claimed in claim 1, wherein the one code part or the multiple code parts are repeatedly subjected to a different variation in each case.

5. The method as claimed in claim 1, wherein different code parts are selected which are varied using the functionality generating a variance with regard to at least one criterion to be examined.

6. The method as claimed in claim 1, wherein all code parts of the program code are varied multiple times.

7. The method as claimed in claim 1, wherein a factor analysis, principal component analysis, multidimensional scaling, cluster analysis or a neuronal network is used as the multivariant analysis.

8. The method as claimed in claim 1, wherein the multivariant analysis is performed using a statistics program running in a computer-assisted manner.

9. The method as claimed in claim 1, wherein the functionality generating the variance is formed by an instrumentation of the code.

10. The method as claimed in claim 1, wherein the functionality generating the variance is formed by a modification of the code.

11. A computer program product, loadable directly into an internal memory of a digital computer, comprising software code sections with which the method of claim 1 are executed, when the computer program product is run on a computer.

12. A data processing system, comprising:
means for varying one or more of the plurality of code parts at least once using a functionality generating a variance with regard to at least one criterion to be examined;
means for executing the data processing system with the varied one or more of the plurality of code parts multiple times;
means for determining a variance of the at least one criterion to be examined of the varied one or more of the plurality of code parts, or of all code parts of the program code; and
means for subjecting a covariance, resulting from the determined variance, to a multivariant analysis.

13. A computer readable medium including program segments for, when executed on a computer device, causing the computer device to implement the method of claim 1.

14. The method as claimed in claim 2, wherein the one code part or the multiple code parts are repeatedly subjected to a different variation in each case.

15. The method as claimed in claim 2, wherein different code parts are selected which are varied using the functionality generating a variance with regard to at least one criterion to be examined.

16. The method as claimed in claim 2, wherein all code parts of the program code are varied multiple times.

17. The method as claimed in claim 2, wherein a factor analysis, principal component analysis, multidimensional scaling, cluster analysis or a neuronal network is used as the multivariant analysis.

18. The method as claimed in claim 2, wherein the multivariant analysis is performed using a statistics program running in a computer-assisted manner.

19. The method as claimed in claim 2, wherein the functionality generating the variance is formed by an instrumentation of the code.

20. The method as claimed in claim 2, wherein the functionality generating the variance is formed by a modification of the code.
